(19) United States
(12) Patent Application Publication
(10) Pub. No.: US 2024/0220549 A1
(43) Pub. Date: Jul. 4, 2024

(54) METHOD AND DEVICE FOR UPDATING DOCUMENT DATA

(71) Applicant: TmaxGAIA CO., Ltd. Co., Ltd., Seongnam-si (KR)

(72) Inventors: Kwanyong KIM, Seoul (KR); Seung Jae LEE, Siheung-si (KR); Moon NAMKOONG, Seongnam-si (KR)

(21) Appl. No.: 18/360,685

(22) Filed: Jul. 27, 2023

(30) Foreign Application Priority Data
Dec. 28, 2022 (KR) 10-2022-0186917

(51) Int. Cl. G06F 16/93; G06F 16/21; G06F 16/25

(52) U.S. Cl. CPC G06F 16/93; G06F 16/212; G06F 16/258; G06Q 10/101

(57) ABSTRACT

Disclosed is a method for updating document data, which is performed by a computing device. The method may include embedding an office entity component related to office entity information of first document data stored in a first database onto a first application. The method may also include processing an event command for the office entity information of the first document data input through the office entity component.

### CROSS-REFERENCE TO RELATED APPLICATIONS

This application claims priority to and the benefit of Korean Patent Application No. 10-2022-0186917 filed in the Korean Intellectual Property Office on Dec. 28, 2022, the entire contents of which are incorporated herein by reference.

### BACKGROUND

### Technical Field

The present disclosure relates to a computer technology field, and more particularly, to a method and a device for updating document data.

### Description of the Related Art

With the development of a network, a structure of a system is simplified, and Internet services using remote communication are actively achieved. In line with that, cloud storage service providers provide remote services capable of storing resources to users. Cloud storage service users can easily access the resource through a cloud storage service anytime, anywhere, without a limit in time and space by using a device connected to the Internet. The users can easily manage the same resource by using various devices by such a cloud storage service.

The cloud storage service is not limited to a personal storage service of the user, and may provide an environment which allows multiple users to share the resource to perform a group-level collaboration. Such a system is referred to as a collaborative system. The collaborative system creates an environment which provides various services, and a collaborative workspace to multiple users or group members to jointly perform group work.

Under a collaborative system environment, as an application that manages document data in a database other than an office application, the office application should be used in order to update the document data.

### BRIEF SUMMARY

The inventors of the present disclosure have appreciated the need to increase the efficiency of a group work by utilizing the document data of the database updated in real time in other applications. The inventors have also appreciated that there is a demand for a technology that can update the document data without a separate office application in the application that manages the document data in the database.

Accordingly, one or more embodiments of the present disclosure provide a method and a device which can update document data without using an office application through embedding of an office entity component in the other application.

An exemplary embodiment of the present disclosure provides a method for updating document data performed by a computing device. The method may include: embedding an office entity component related to office entity information of first document data stored in a first database onto a first application; and processing an event command for the office entity information of the first document data input through the office entity component.

Alternatively, the embedding of the office entity component related to the office entity information of the first document data stored in the first database onto the first application may include acquiring at least some of the first document data including the office entity information from the first database of the first application, converting the office entity information based on a schema of a second database, in which the schema of the second database may be a schema defined in a format which is used in the office entity component, and providing the office entity component based on the converted office entity information through the first application.

Alternatively, the providing of the office entity component based on the converted office entity information through the first application may include displaying the office entity information of the first document data through the office entity component on the first application.

Alternatively, the providing of the office entity component based on the converted office entity information through the first application may include permitting edition for the office entity information of the first document data through the office entity component on the first application.

Alternatively, the processing of the event command for the office entity information of the first document data input through the office entity component may include receiving the event command for the office entity information of the first document data through the office entity component on the first application, and generating a first update request for the office entity information of the first document data on the second database based on a result of processing the event command.

Alternatively, the processing of the event command for the office entity information of the first document data input through the office entity component may further include generating a second update request for the office entity information of the first document data on the first database based on the result of processing the event command, in which the second update request is generated based on the schema of the first database.

Alternatively, the processing of the event command for the office entity information of the first document data input through the office entity component may include displaying the result of processing the event command through the office entity component on the first application.

Alternatively, the office entity information may include information related to at least one of office entities such as text paragraph, tables, or figures.

Another exemplary embodiment of the present disclosure provides a computing device for performing a method for updating document data. The device may include: a processor including at least one core; and a memory including program codes executable by the processor, and the processor may be configured to embed an office entity component related to office entity information of first document data stored in a first database onto a first application, and process an event command for the office entity information of the first document data input through the office entity component.

Still another exemplary embodiment of the present disclosure provides computer program stored in a computer-readable storage medium. The computer program may execute operations for a method for updating document data when the computer program is executed by one or more processors, and the method may include: embedding an office entity component related to office entity information of first document data stored in a first database onto a first application; and processing an event command for the office entity information of the first document data input through the office entity component.

According to an exemplary embodiment of the present disclosure, it is possible to provide a method and a device which can update document data without using an office application through embedding of an office entity component in the other application.

### BRIEF DESCRIPTION OF THE SEVERAL VIEWS OF THE DRAWINGS

FIG. 1 is a block diagram of a computing device for performing a method for updating document data according to some exemplary embodiments of the present disclosure.

FIG. 2 is a diagram for describing operations of components for performing a method for updating document data according to some exemplary embodiments of the present disclosure.

FIG. 3 is a flowchart of a method for updating document data according to some exemplary embodiments of the present disclosure.

FIG. 4 is an alternative flowchart of a method for updating document data according to some exemplary embodiments of the present disclosure.

FIG. 5 is another alternative flowchart of a method for updating document data according to some exemplary embodiments of the present disclosure.

FIG. 6 is a simple and normal schematic view of an exemplary computing environment in which some exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component,” “module,” “system,” and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A,” “a case including only B,” and “a case in which A and B are combined.”

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

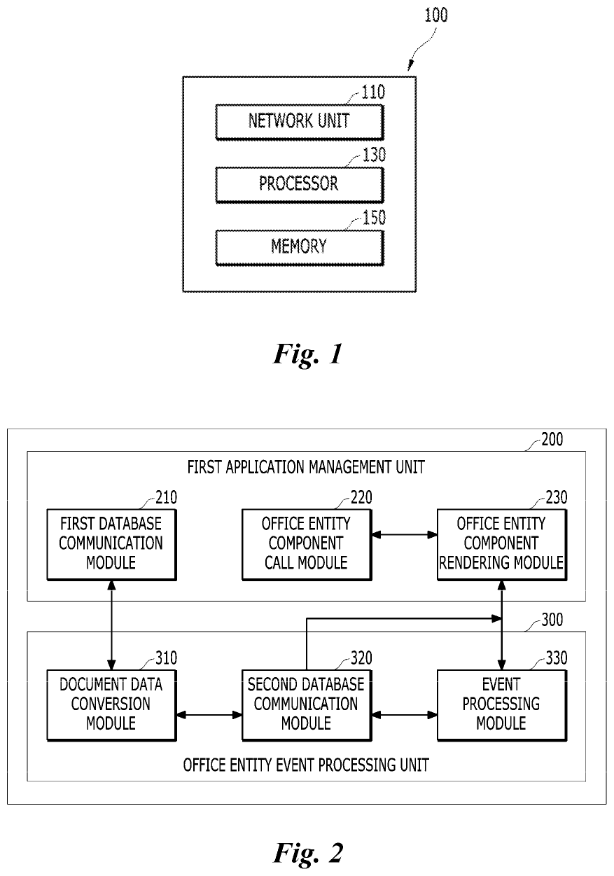

FIG. 1 is a block diagram of a computing device for performing a method for updating document data according to some exemplary embodiments of the present disclosure.

As illustrated in FIG. 1, the computing device 100 may include a processor 110, a memory 130, and a network unit 150. A configuration of the computing device 100 illustrated in FIG. 1 is only an example shown through simplification. In some exemplary embodiments of the present disclosure, the computing device 100 may include other components for performing a computing environment of the computing device 100 and only some of the disclosed components may constitute the computing device 100.

The processor 110 may be constituted by one or more cores and may include processors for data analysis and processing, which include a central processing unit (CPU), a general purpose graphics processing unit (GPGPU), a tensor processing unit (TPU), and the like of the computing device. The processor 110 may read a computer program stored in the memory 130 to perform data conversion, computation, generation, etc., for performing the method for updating the document data according to some exemplary embodiments of the present disclosure.

According to some exemplary embodiments of the present disclosure, the processor 110 may perform steps for performing the method for updating the document data described below. Further, the processor 110 may implement various units and modules for performing the method for updating the document data. For example, hereinafter, as described with reference to FIG. 2, the processor 110 may implement a first application management unit 200 and an office entity event processing unit 300, and components thereof. Further, the first application management unit 200 and the office entity event processing unit 300 may be implemented to perform various operations implemented by a general computer technology other than an operation described in the present disclosure.

According to some exemplary embodiments of the present disclosure, the memory 130 may store any type of information generated or determined by the processor 110 and any type of information received by the network unit 150. For example, the memory 130 may store data generated in the process of performing the method for updating the document data by the processor 110. Further, the memory 130 may store data received from an external device such as another server or client terminal in the process of performing the method for updating the document data by the processor 110. However, although not limited thereto, the memory 130 may store various information for performing the method for updating the document data according to some exemplary embodiments of the present disclosure. For example, the memory 130 may include a first database or a second database described below. As another example, the memory 130 may store data received from the first database or the second database positioned outside.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to some exemplary embodiments of the present disclosure may use an arbitrary type known wired/wireless communication systems.

The network unit 150 may transmit and receive information processed by the processor 110, a user interface, etc., through communication with the other terminal. For example, the network unit 150 may provide the user interface generated by the processor 110 to a client (e.g., a user terminal). Further, the network unit 150 may receive an external input of a user applied to the client and deliver the received external input to the processor 110. Further, the network unit 150 may receive an external input of a user applied to the client and deliver the received external input to the processor 110. In this case, the processor 110 may process operations such as output, modification, change, addition, etc., of information provided through the user interface based on the external input of the user delivered from the network unit 150. Further, the network unit 150 may transmit/receive data to/from a first database or a second database positioned outside.

Meanwhile, according to some exemplary embodiments of the present disclosure, the computing device 100 as a computing system that transmits and receives information to and from the client through communication may include a server. In this case, the client may be any type of terminal which may access the server. For example, the computing device 100 which is the server receives a query from a user terminal to generate a single information processing result corresponding to the query. In this case, the computing device 100 which is the server may provide the user interface including the processing result to the user terminal. In this case, the user terminal may output the user interface received from the computing device 100 as the server, and receive and process the information through an interaction with the user. For example, the computing device 100 which is the server may provide a plurality of applications including an office application to the user terminal. In some examples, the computing device 100 which is the server may implement a collaborative system which provides a collaborative workspace to jointly perform group work.

In an additional exemplary embodiment, the computing device 100 may also include any type of terminal that performs additional information processing by receiving a data resource generated in any server.

FIG. 2 is a diagram for describing a component for performing a method for updating document data according to some exemplary embodiments of the present disclosure.

Referring to FIG. 2, operations of the exemplary first application management unit 200 and office entity event processing unit 300 implemented by the processor 110 will be described.

According to some exemplary embodiments of the present disclosure, the first application management unit 200 may embed an office entity component related to office entity information of first document data stored in the first database on the first application. In addition, according to some exemplary embodiments of the present disclosure, the office entity event processing unit 300 may process an event command for the office entity information of the first document data input through the office entity component. Hereinafter, the operations of the first application management unit 200 and the office entity event processing unit 300 will be described jointly with operations of respective individual components.

The first application management unit 200 may provide the first application that uploads, keeps, and manages a document onto the first database. Here, the first application may include various applications other than an office application which may prepare/edit the document data. For example, the first application may include a chatting application that provides chatting between members under the collaborative system. As another example, the first application may include an application that uploads, and keeps/manages the document data. However, although not limited thereto, and the first application management unit 200 may include any application other than the office application. The first application management unit 200 may include modules for performing a unique operation (e.g., a chatting interface providing module), but the modules are not illustrated in FIG. 2 for simple description.

The first application management unit 200 may include a first database communication module 210 that transmits/receives data to/from the first database. The first database may store various data processed by the first application. For example, when the first application is the chatting application, the first database communication module 210 may store document data shared through the chatting application in the first database. In this case, the first database communication module 210 may transmit/receive data managed by the first application such as the document data in the first database to/from the first database. Further, the first database communication module 210 may transmit the data received from the first database to the other application. Further, the first database communication module 210 may store the data transmitted to the other application in the first database. Although not limited thereto, and the first application management unit 200 may perform various operations related to the first database.

The first application management unit 200 may include an office entity component call module 220 that calls the office entity component. For example, the office entity component call module 220 may receive a command for calling the office entity component related to the office entity information of the document data stored in the first database. Here, the office entity information may be information related to office entities such as text paragraph, tables, or figures included in the document data. For example, when one person among group members of the collaborative system shares and edits a table included in the first document data, the office entity component call module 220 may receive a command for calling the office entity component for the table included in the first document data in the first application (e.g., chatting application). However, although not limited thereto, the office entity component call module 220 may receive the command for calling the office entity component by various schemes.

The first application management unit 200 may include an office entity component rendering module 230 that provides the office entity component onto the first application according to the command for calling the office entity component. For example, when the office entity component call module 220 receives the command for calling the office entity component, the office entity component rendering module 230 may embed the office entity component related to the office entity information onto the first application. In some examples, when the office entity information is information on the table of the first document data, the office entity component embedded onto the first application may display the table included in the first document data in a screen region set by the first application. Further, the office entity component embedded onto the first application may permit the table included in the first document data to be edited through the first application. Although not limited thereto, the office entity component may perform various operations for the office entity information.

Here, the embedding may mean a form in which the office entity component is provided through the first application, but does not have dependency on an actual internal operation of the first application. For example, as described below, an event for the office entity component may be processed by an office entity event processing unit 300 bound to the office entity component without the dependency on the first application.

An exemplary operation of embedding the office entity component is described as below. In order to embed the office entity component, the first document data may be converted through a document data conversion module 310 of the office entity event processing unit 300. To this end, the document data conversion module 310 may acquire (all or some) of the first document data including the office entity information from the first database through the first database communication module 220. In addition, the document data conversion module 310 may convert the office entity information of the first document data among the acquired first document data based on a schema of the second database. In detail, the document data stored in the first database may be stored according to the schema of the first database. Here, the schema of the first database may be a schema defined in a format which may be used in the first database. Therefore, the document data stored in the first database needs to be converted according to the schema of the second database which may be used in the office entity component. In some examples, the document data conversion module 310 may acquire a schema defined in a format which may be used in the office entity component stored in the second database through a second database communication module 320. Here, the second database may be a database that stores various data processed through the office entity component. In some examples, the schema of the second database may show data on a screen by using the office entity component, and define a format for editing data.

The document data conversion module 310 may convert the office entity information of the first document data into the format which may be used in the office entity component based on the schema of the second database. The office entity information converted by the document data conversion module 310 may be stored in the second database through the second database communication module 320. In this case, the office entity component rendering module 230 may embed the office entity component onto the first application by using office entity information converted to suit the office entity component stored in the second database. However, although not limited thereto, the office entity component may be embedded by various schemes.

As described above, the office entity component embedded on the first application may display the office entity information and permit edition for the office entity information. For example, a user event may occur which edits the office entity information through the office entity component embedded onto the first application. In this case, the event processing module 330 may receive an event command for the office entity information of the first document data corresponding to the user event which occurs through the office entity component on the first application. For example, the event command may be a command for modifying the table included in the first document data displayed through the office entity component. In this case, the event processing module 330 bound to the office entity component may process the event command without the dependency on the first application. In addition, the event processing module 330 may generate a first update request for the office entity information of the first document data on the second database based on a result of processing the event command. According to the first update request, the office entity information of the first document data stored in the second database may be updated by reflecting the result of processing the event command.

When the update for the second database is completed, the result of processing the event command by requesting and receiving updated data of the second database may be displayed on the office entity component on the first application so as for a user(s) to identify the result of processing the event almost in real time. Further, for synchronization of the first document data stored in the first database and the second database, respectively, the result of processing the event command needs to be reflected onto the first document data stored in the first database. To this end, the event processing module 330 may generate a second update request for the office entity information of the first document data on the first database based on the result of processing the event command. Here, the second update request may be generated based on the schema of the first database. In detail, the data stored in the second database may be stored according to the schema of the second database which may be used in the office entity component. As described above, the document data stored in the first database may be stored according to the schema of the first database defined in the format which may be used in the first database. Therefore, in order to store the data stored according to the schema of the second database in the first database, data to be stored in the first database needs to be converted into a format suitable for the schema of the first database. To this end, the second update request may be generated according to the schema of the first database.

In some examples, the event processing module 330 converts the first update request according to the schema of the second database to generate a second update request. In this case, the second update request may be used for updating the first document data stored in the first database through the first database communication module 210. Therefore, when the first document data is read or downloaded by the office application, the first document data to which contents updated through the edition through the office entity component are reflected may be utilized.

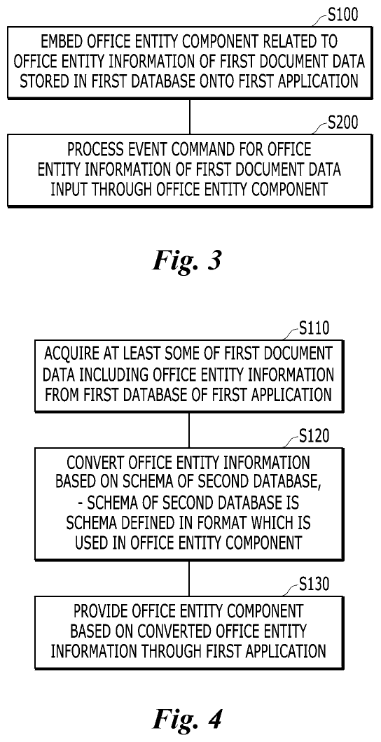

FIG. 3 is a flowchart of a method for updating document data according to some exemplary embodiments of the present disclosure.

According to some exemplary embodiments of the present disclosure, the method for updating the document data performed by the computing device may include a step s100 of embedding an office entity component related to office entity information of first document data stored in a first database onto a first application.

According to some exemplary embodiments of the present disclosure, the method for updating the document data performed by the computing device may include a step s200 of processing an event command for the office entity information of the first document data input through the office entity component.

The steps according to some exemplary embodiments of the present disclosure described above are presented just for the description, and some steps may be omitted or separate steps may be added. Further, the steps described above may be performed according to a predetermined order.

FIG. 4 is an alternative flowchart of a method for updating document data according to some exemplary embodiments of the present disclosure.

Hereinafter, alternative steps included in the step s100 of embedding the office entity component related to the office entity information of the first document data stored in the first database on the first application will be described.

According to some exemplary embodiments of the present disclosure, the step s100 of embedding the office entity component related to the office entity information of the first document data on the first application may include a step s110 of acquiring at least some of the first document data including the office entity information from the first database of the first application.

According to some exemplary embodiments of the present disclosure, the step s100 of embedding the office entity component related to the office entity information of the first document data on the first application may include a step s120 of converting the office entity information based on a schema of a second database. Here, the schema of the second database may be a schema defined in a format which may be used in the office entity component.

According to some exemplary embodiments of the present disclosure, the step s100 of embedding the office entity component related to the office entity information of the first document data on the first application may include a step s130 of providing the office entity component based on the converted office entity information through the first application.

The steps according to some exemplary embodiments of the present disclosure described above are presented just for the description, and some steps may be omitted or separate steps may be added. Further, the steps described above may be performed according to a predetermined order. Hereinafter, alternative steps included in the step s130 of providing the office entity component based on the converted office entity information through the first application will be described.

According to some exemplary embodiments of the present disclosure, the step s130 of providing the office entity component based on the converted office entity information through the first application may include a step (not illustrated) of displaying the office entity information of the first document data through the office entity component on the first application.

According to some exemplary embodiments of the present disclosure, the step s130 of providing the office entity component based on the converted office entity information through the first application may include a step of permitting edition for the office entity information of the first document data through the office entity component on the first application.

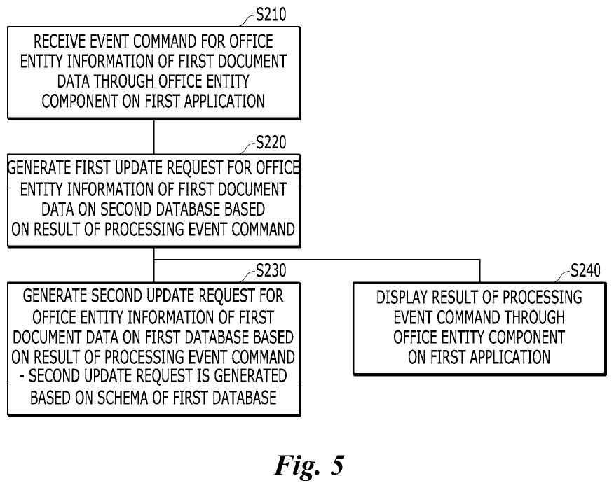

FIG. 5 is another alternative flowchart of a method for updating document data according to some exemplary embodiments of the present disclosure.

Hereinafter, alternative steps included in the step s200 of processing the event command for the office entity information of the first document data input through the office entity component will be described.

According to some exemplary embodiments of the present disclosure, the step s200 of processing the event command for the office entity information of the first document data input through the office entity component may include a step s210 of receiving the event command for the office entity information of the first document data through the office entity component on the first application.

According to some exemplary embodiments of the present disclosure, the step s200 of processing the event command for the office entity information of the first document data input through the office entity component may include a step s220 of generating the first update request for the office entity information of the first document data on the second database based on a result of processing the event command.

According to some exemplary embodiments of the present disclosure, the step s200 of processing the event command for the office entity information of the first document data input through the office entity component may include a step s230 of generating the second update request for the office entity information of the first document data on the first database based on the result of processing the event command. Here, the second update request may be generated based on the schema of the first database.

According to some exemplary embodiments of the present disclosure, the step s200 of processing the event command for the office entity information of the first document data input through the office entity component may include a step s240 of displaying the result of processing the event command through the office entity component on the first application.

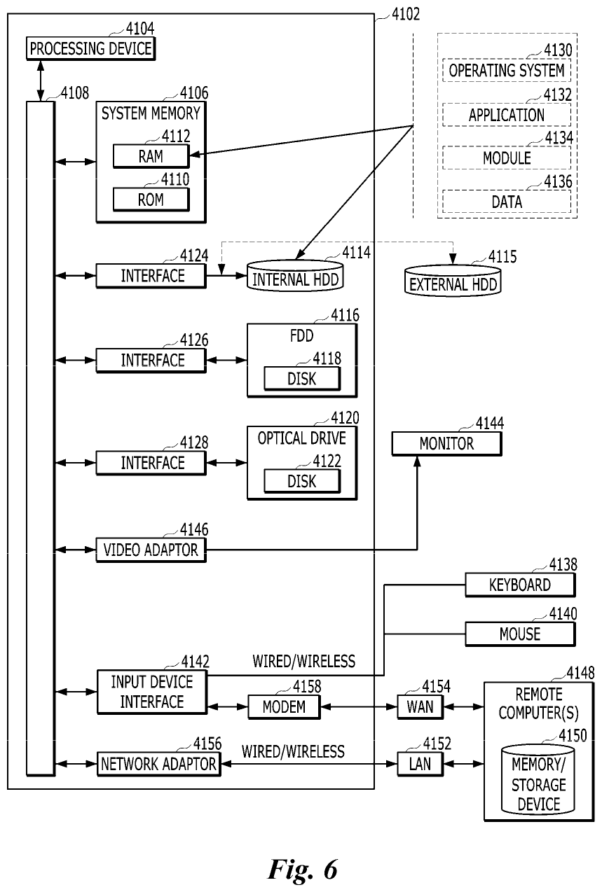

The steps according to some exemplary embodiments of the present disclosure described above are presented just for the description, and some steps may be omitted or separate steps may be added. Further, the steps described above may be performed according to a predetermined order. FIG. 6 is a simple and normal schematic view of an exemplary computing environment in which some exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for updating document data performed by a computing device, the method comprising:
embedding an office entity component related to office entity information of first document data stored in a first database onto a first application; and
processing an event command for the office entity information of the first document data input through the office entity component.

2. The method of claim 1, wherein the embedding of the office entity component related to the office entity information of the first document data onto the first application includes:
acquiring at least some of the first document data including the office entity information from the first database of the first application,
converting the office entity information based on a schema of a second database, wherein the schema of the second database is a schema defined in a format which is used in the office entity component, and
providing the office entity component based on the converted office entity information through the first application.

3. The method of claim 2, wherein the providing of the office entity component based on the converted office entity information through the first application includes:
displaying the office entity information of the first document data through the office entity component on the first application.

4. The method of claim 2, wherein the providing of the office entity component based on the converted office entity information through the first application includes:
permitting edition for the office entity information of the first document data through the office entity component on the first application.

5. The method of claim 1, wherein the processing of the event command for the office entity information of the first document data input through the office entity component includes:
receiving the event command for the office entity information of the first document data through the office entity component on the first application, and
generating a first update request for the office entity information of the first document data on the second database based on a result of processing the event command.

6. The method of claim 5, wherein the processing of the event command for the office entity information of the first document data input through the office entity component further includes:
generating a second update request for the office entity information of the first document data on the first database based on the result of processing the event command, wherein the second update request is generated based on the schema of the first database.

7. The method of claim 5, wherein the processing of the event command for the office entity information of the first document data input through the office entity component includes:
displaying the result of processing the event command through the office entity component on the first application.

8. The method of claim 1, wherein the office entity information includes information related to at least one of text paragraph, tables, or figures.

9. A computing device for performing a method for updating document data, comprising:
a processor including at least one core; and
a memory including program codes executable by the processor,
wherein the processor is configured to:
embed an office entity component related to office entity information of first document data stored in a first database onto a first application, and
process an event command for the office entity information of the first document data input through the office entity component.

10. A computer program stored in a computer-readable storage medium, wherein the computer program executes operations for a method for updating document data when the computer program is executed by one or more processors, the method comprising:
embedding an office entity component related to office entity information of first document data stored in a first database onto a first application; and
processing an event command for the office entity information of the first document data input through the office entity component.
